(19) United States
(12) Patent Application Publication
(10) Pub. No.: US 2024/0228339 A1
(43) Pub. Date: Jul. 11, 2024

(54) ELECTROCHEMICAL MEMBRANE APPARATUS INCLUDING AN ELECTROCHEMICAL MEMBRANE REACTOR, AND RELATED METHODS

(71) Applicant: Battelle Energy Alliance, LLC, Idaho Falls, ID (US)

(72) Inventors: Qiang Wang, Idaho Falls, ID (US); Luis A. Diaz Aldana, Idaho Falls, ID (US); Daniel M. Ginosar, Idaho Falls, ID (US); Meng Shi, Idaho Falls, ID (US)

(21) Appl. No.: 18/557,030

(22) PCT Filed: May 4, 2022
(86) PCT No.: PCT/US2022/072109

§ 371 Date: Oct. 24, 2023

Related U.S. Application Data
(60) Provisional application No. 63/184,643, filed on May 5, 2021.
(60) Provisional application No. 63/269,755, filed on Mar. 22, 2022.

(51) Int. Cl. C02F 1/467; C02F 1/461; C02F 101/20; C02F 103/16; C02F 103/34

(52) U.S. Cl. CPC C02F 1/4676; C02F 1/46109; C02F 2001/46138; C02F 2001/46161; C02F 2101/203; C02F 2103/16; C02F 2103/34; C02F 2201/46115; C02F 2209/06; C02F 2209/22

(57) ABSTRACT

A method of removing impurities using an electrochemical membrane apparatus comprising introducing a leaching solution into an electrochemical membrane reactor. The leaching solution of the electrochemical apparatus comprises copper, aluminum, iron, cobalt, manganese, and nickel. The electrochemical membrane reactor comprises at least one positive electrode and at least one negative electrode, and the leaching solution is in contact with the at least one negative electrode. A current is applied through the electrochemical membrane reactor to adjust a pH of the leaching solution and copper is deposited on the at least one negative electrode. The aluminum and the iron are removed from the leaching solution, and the cobalt, the manganese, and the nickel are recovered from the leaching solution. An electrochemical membrane apparatus including an electrochemical membrane reactor is also disclosed.

### CROSS REFERENCE TO RELATED APPLICATIONS

This application is a national phase entry under 35 U.S.C. § 371 of International Patent Application US2022/072109, filed May 4, 2022, designating the United States of America and published as International Patent Publication WO 2022/236283 A1 on Nov. 10, 2022, which claims the benefit under Article 8 of the Patent Cooperation Treaty to U.S. Patent Application Ser. No. 63/184,643, filed May 5, 2021, and to U.S. Patent Application Ser. No. 63/269,755, filed Mar. 22, 2022.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure generally relate to electrochemical membrane reactors. In particular, embodiments of the disclosure relate to electrochemical membrane reactors for recovering impurities, related methods and systems.

### BACKGROUND

For decades, portable electrical power supplies have taken the form of batteries that release electrical energy from an electrochemical reaction. Various battery chemistries, such as conventional “dry cell” carbon flashlight batteries, and lead acid “wet” cells common in automobiles have provided adequate portable electrical power. Modern electronics, however, place significantly greater demands on the longevity and mass of batteries. Battery power has traditionally come at a premium of the mass required for the charge material for generating sufficient current. Conventional flashlight batteries deliver only low current. Automobile batteries for delivering an intense but brief high amperage flow to a starter motor are very dense and large. Modern electronic devices, such as cell phones, computing devices, and automobiles, demand substantial current delivery while being lightweight and small enough to avoid hindering the portability of the host device.

Rechargeable nickel-cadmium (NiCad) and nickel metal hydride (NiMH) had gained popularity for rechargeable batteries for portable devices. Recently, however, advances in lithium-ion batteries (LIBs) have been significant such that they have become the most popular power source for portable electronics equipment, and are also growing in popularity for military, electric vehicle, and aerospace applications. Continuing development of personnel electronics, hybrid and electric vehicles, ensures that Li-ion batteries will continue to be increasingly in demand.

Lithium-ion batteries, such as nickel-cadmium (NiCd) and nickel-metal hydride (NiMH), the earlier battery types, have a limited number of charge cycles. Thus, as many electric vehicles meet their lifetimes, LIB is expected to be an important component of the solid waste group. Recycling of the filler material in the lithium battery not only reduces the amount of waste, but also produces an active filler material for a new battery. Recycling can significantly reduce the amount of lithium required. Spent lithium ion batteries also include useful metals, such as cobalt, manganese, and nickel. The spent LIBs include higher concentrations of cobalt, manganese, and nickel than natural ore. Also, the disposal of the battery requires the extraction of new metal for the cathode material, and the mining requires greater environmental impact and cost than simply recycling. In short, the recycling of lithium-ion batteries offers a profitable outlet for battery manufacturers, as well as protecting the environment and saving energy, as well as providing an inexpensive supply of active cathode materials for new batteries.

### BRIEF SUMMARY

This summary does not identify key features or essential features of the claimed subject matter, nor does it limit the scope of the claimed subject matter.

Accordingly, in some embodiments, a method of removing impurities using an electrochemical membrane apparatus (e.g., electrochemical apparatus) is disclosed. The method comprises introducing a leaching solution into an electrochemical membrane reactor, the leaching solution comprising copper, aluminum, iron, cobalt, manganese, and nickel, the electrochemical membrane reactor comprising at least one positive electrode and at least one negative electrode, and the leaching solution in contact with the at least one negative electrode. A current is applied through the electrochemical membrane reactor to adjust a pH of the leaching solution. Copper is deposited on the at least one negative electrode and the aluminum and the iron are removed from the leaching solution. The cobalt, the manganese, and the nickel are recovered from the leaching solution.

Accordingly, in some embodiments, an electrochemical membrane apparatus is disclosed and comprises an electrochemical membrane reactor comprising at least one positive electrode configured to act as a sacrificial anode or a noble metal anode, and at least one negative electrode configured to provide a base material for electroplating a metal from a leaching solution source coupled to the electrochemical membrane reactor. The at least one membrane is between the at least one positive electrode and the at least one negative electrode and is formulated to conduct ions from the positive electrode to the negative electrode. A power source is electrically coupled to the positive electrode and the negative electrode and configured to apply current between the negative electrode and the positive electrode.

### BRIEF DESCRIPTION OF THE DRAWINGS

The illustrations presented in this disclosure are not meant to be actual views of any particular electrochemical apparatus, electrochemical membrane reactor, or component thereof, but are merely idealized representations employed to describe illustrative embodiments. Thus, the drawings are not necessarily to scale.

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a schematic diagram of an electrochemical apparatus including an electrochemical membrane reactor according to embodiments of the disclosure;

FIG. 2 is a schematic diagram of an electrochemical apparatus including an electrochemical membrane reactor according to embodiments of the disclosure;

FIG. 3 is a schematic diagram of an electrochemical apparatus including an electrochemical membrane reactor according to embodiments of the disclosure;

FIG. 4 is a schematic diagram of an electrochemical apparatus including an electrochemical membrane reactor according to embodiments of the disclosure;

FIG. 5 is a schematic diagram of an electrochemical apparatus including an electrochemical membrane reactor according to embodiments of the disclosure; and

FIG. 6 is a flow diagram of a method of removing impurities using an electrochemical apparatus according to embodiments of the disclosure.

### DETAILED DESCRIPTION

An electrochemical apparatus including an electrochemical membrane reactor (e.g., electrochemical cell, electrochemical reactor), and methods for removing impurities including aluminum (Al) and iron (Fe) and recovering cobalt (Co), manganese (Mn), and nickel (Ni) from a leaching solution (e.g., leachate) are disclosed. The methods and apparatuses disclosed may be utilized for removing and recovering cobalt, manganese, and nickel during the process of recycling spent Li-ion batteries. The methods and apparatuses disclosed may additionally be utilized for extracting cobalt and nickel from mine tailings produced during mining operations. The electrochemical membrane reactor according to embodiments of the disclosure may significantly increase the nickel and cobalt recovery efficiency compared with conventional precipitation methods.

In embodiments of the disclosure, an electrochemical membrane reactor of an electrochemical apparatus includes a positive electrode (anode), a negative electrode (cathode), and a membrane (e.g., an electrochemical membrane, an anionic membrane, an ionic membrane) between the positive electrode and the negative electrode. The electrochemical membrane reactor is contained in a housing and includes the leaching solution surrounding the negative electrode as the catholyte, and an anolyte surrounding the positive electrode. In some embodiments, the method includes directing the leaching solution into the electrochemical membrane reactor, applying an electric current to the reactor, and increasing the pH of the leaching solution. The methods and apparatuses of the disclosure may be more efficient (e.g., increasing impurity recovery rates; reducing equipment, material, and/or energy requirements; etc.) as compared to conventional methods, and conventional apparatuses for removing impurities and recovering cobalt, manganese, and nickel from a leaching solution.

The following description provides specific details, such as material compositions and processing conditions in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components are inherently disclosed herein and that adding various conventional process components and acts would be in accord with the disclosure. In addition, the drawings accompanying the application are for illustrative purposes only, and are not meant to be actual views of any particular material, device, or system.

As used herein, the singular forms “a,” “an,” and “the” are intended to include the plural forms as well, unless the context clearly indicates otherwise.

As used herein, the term “about” in reference to a given parameter is inclusive of the stated value and has the meaning dictated by the context (e.g., it includes the degree of error associated with measurement of the given parameter).

As used herein, “and/or” includes any and all combinations of one or more of the associated listed items.

As used herein, the term “configured” refers to a size, shape, material composition, material distribution, and arrangement of one or more of at least one structure and at least one apparatus facilitating operation of one or more of the structure and the apparatus in a pre-determined way.

As used herein the term “electrolyte” means and includes an ionic conductor, which can be in a solid state, a liquid state, or a gas state (e.g., plasma).

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein).

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

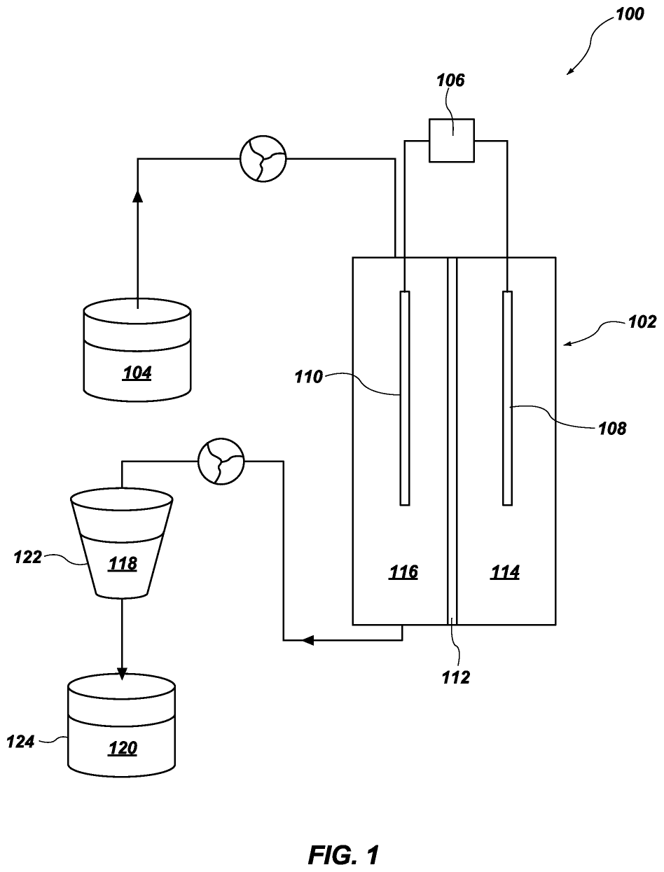

An embodiment of the disclosure will now be described with reference to FIG. 1, which schematically illustrates an electrochemical apparatus 100 for removing impurities and recovering cobalt, manganese, and nickel from a leaching solution. As shown in FIG. 1, the electrochemical apparatus 100 may include an electrochemical membrane reactor 102, and a leaching solution source 104. The electrochemical membrane reactor 102 is electrically connected (e.g., coupled) to a power source 106, and includes a positive electrode 108 (e.g., anode), a negative electrode 110 (e.g., cathode), and a membrane 112 (e.g., anionic exchange membrane). The membrane 112 is disposed between the positive electrode 108 and the negative electrode 110.

The membrane 112 is configured and formulated to conduct ions (e.g., SO₄²⁻) from the positive electrode 108 to the negative electrode 110, while electrically insulating the negative electrode 110 from the positive electrode 108 and preventing the migration of molecules and cations therethrough. The membrane 112 includes an electrolyte material having an ionic conductivity greater than or equal to about 1.5 millisiemens per centimeter (mS/cm). By way of non-limiting example, the membrane 112 may comprise an anionic exchange membrane, such as a FUMASEP® FAA-3-PE-30.

The membrane 112 separates the electrochemical membrane reactor into negative electrode 110 (e.g., cathode) and positive electrode 108 (e.g., anode) chambers. The positive electrode 108 is submerged in an anolyte 114, while the negative electrode 110 is submerged in a leaching solution 116 (e.g., catholyte). The anolyte 114 may be a solution including K₂SO₄, NaSO₄, CaSO₄, or a combination thereof. The leaching solution source 104 may be a leaching solution obtained from a cobalt and/or nickel mine (e.g., mine tailing), ferromanganese slag from ferromanganese alloy manufacturing, or spent Li-ion batteries. By way of non-limiting example, the leaching solution obtained from the cobalt mine may include a metal sulfide, such as laterite, pentlandite, chalcopyrite, or cobaltite. The minerals may undergo a roasting process to convert the metal sulfide into metal oxides and metal sulfates. The leaching solution 116 from the leaching solution source 104 may be an aqueous solution (e.g., including water (H₂O)). The leaching solution 116 may include MnSO₄, NiSO₄, CoSO₄, CuSO₄, Al₂(SO₄)₃, Fe₂(SO₄)₃, or a combination thereof.

As described in further detail below, the electrochemical membrane reactor 102 of electrochemical apparatus 100 may be operated to increase the pH value of the leaching solution 116 without using a basic solution (e.g., a base). In other words, no basic solution is added to the leaching solution 116 to increase its pH. By increasing the pH of the leaching solution 116, impurities, such as copper, aluminum, and iron in the form of copper ions (Cu²⁺ ions), aluminum ions (Al³⁺ ions), and iron ions (Fe³⁺ ions), may be removed from the leaching solution 116. After removing the impurities, the concentration of each of Cu, Al, and Fe in a recovered leaching solution 120 may be equal to about 1×10⁻⁵ M by electroplating the Cu²⁺ ions onto the negative electrode 110 and then precipitating the Al³⁺ ions and Fe³⁺ ions. Specifically, the concentration of each of Cu, Al, and Fe in the recovered leaching solution 120 may be sufficient to synthesize a battery cathode. The Al³⁺ ions and Fe³⁺ ions may be precipitated in a vessel 122 (e.g., container, chamber, separator unit) containing a treated leaching solution 118 of the electrochemical apparatus 100.

During use and operation of the electrochemical apparatus 100, the leaching solution 116 from the leaching solution source 104 is introduced into the electrochemical membrane reactor 102 on the side of the negative electrode 110 (e.g., in the negative electrode chamber). A potential difference (e.g., voltage) is applied between the positive electrode 108 and the negative electrode 110 of the electrochemical membrane reactor 102 by the power source 106. Electrons travel from a negative terminal of the power source 106 to the negative electrode 110, reducing H₂O, O₂, and metal ions. The positive electrode 108 may be a noble metal or a sacrificial metal. H₂O loses an electron on a noble metal positive electrode. Alternatively, the sacrificial metal positive electrode loses electrons and dissolves into the anolyte 114. The lost electron travels into the positive terminal of the power source 106. The negative charge of the negative electrode 110 attracts positively charged Cu²⁺ ions from the leaching solution 116. The Cu²⁺ ions deionize (e.g., lose their positive charge) and form on (e.g., deposit on) the negative electrode 110 resulting in a thin layer of copper metal on the surface of the negative electrode 110. The process of forming the copper metal on the surface of another material is known in the art as electroplating. The electrochemical reaction occurring on the surface of the negative electrode 110 is in accordance with the following equation:

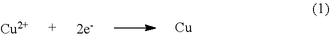

The reduction of H₂O in the leaching solution 116 generates hydroxide ions (OH⁻ ions) and hydrogen gas (H₂). Additionally, air may be purged into the electrochemical membrane reactor 102 to reduce H2O and generate hydroxide ions. The electrochemical reactions occurring on the negative electrode 110 side of the electrochemical membrane reactor 102 is in accordance with the following equations:

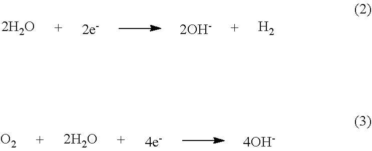

The generation of the OH⁻ ions as a result of the application of the potential difference increases the pH of the leaching solution 116 to within a range of from about 5.2 to about 12. The increase of the pH of the leaching solution 116 produces the treated leaching solution 118, which flows from the chamber of the negative electrode 110 of the electrochemical membrane reactor 102 to the vessel 122. The Al³⁺ ions and the Fe³⁺ ions precipitate out of the treated leaching solution 118, which is contained in the vessel 122 of the electrochemical apparatus 100. The vessel 122 is fluidly connected to the electrochemical membrane reactor 102. The electrochemical reaction of the precipitation of the impurities of aluminum and iron are in accordance with the following equations:

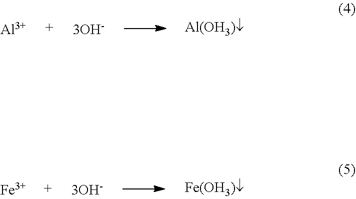

The positive electrode 108 may be formed of and include at least one metallic material, such as nickel (Ni), zinc (Zn), copper (Cu), iron (Fe), or lead (Pb), or a noble metal, such as platinum (Pt), titanium (Ti) coated with iridium oxide (IrO₂), gold (Au), titanium coated with platinum, or other noble metal. By way of non-limiting example, when using Ni, Zn, or Pb as the positive electrode 108, the positive electrode 108 acts as a sacrificial anode and the metal dissolves into the anolyte 114 during the impurity removal method described above with reference to equations (1)-(5). If the positive electrode 108 is a noble metal, an acid is generated from the positive electrode 108 directly during the impurity removal process. In some embodiments, the positive electrode 108 is nickel. By way of non-limiting example, the electrochemical reactions occurring on the surface of a positive electrode 108 comprising nickel is in accordance with the following equations:

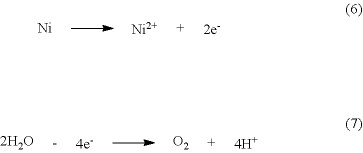

After the impurities (e.g., copper, aluminum, iron) have been removed (e.g., filtered out) from the leaching solution 116, the positive electrode 108 material that was sacrificial during the previous reactions of equations (6) and (7) may be recovered by reversing the polarization of the electrochemical membrane reactor 102 and restoring the dissolved metal by electroplating the positive electrode 108 during a reactor restoration act. The electrochemical reactions occurring on the surface of the positive electrode 108, which is now negatively charged, is in accordance with the following equation:

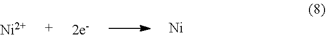

The material compositions of the positive electrode 108 and the negative electrode 110 may be selected relative to one another, the material composition of the membrane 112, and the operating conditions (e.g., current density, temperature) of the electrochemical membrane reactor 102. For example, the operating temperature may be room temperature. The current density may depend on the design of the electrochemical membrane reactor including the volume leaching solution. By way of non-limiting example, the electrochemical membrane reactor may utilize a current from about 20 mA to about 40 mA current to recycle 120 ml of leaching solution. However, the applied current may be larger for other configurations of the electrochemical membrane reactor. Furthermore, the electrochemical membrane reactor may utilize greater than or equal to 2.5 A current for 5 liters of leaching solution, and greater than or equal to 10 A current for 20 liters of leaching solution. The negative electrode 110 may be a 2-dimensional (2-D) immerged plate electrode (e.g., immerged plate). The 2-D immerged plate negative electrode 110 may be formed of and include at least one catalytic material, such as graphite, copper, iron, titanium or nickel. In some embodiments, the negative electrode 110 is copper.

The treated leaching solution 118 containing the precipitates generated from the reaction of equations (4) and (5) is transported from the electrochemical membrane reactor 102 to the vessel 122. After removing the precipitates, the recovered leaching solution 120 is transported to the container 124. The recovered leaching solution 120 is substantially free from aluminum, iron, and copper as a result of electroplating the copper and precipitating the aluminum and iron. However, the recovered leaching solution 120 may include manganese (Mn), cobalt (Co), and nickel (Ni). Therefore, the electrochemical membrane reactor 102 may be used to recover materials such as manganese (Mn), cobalt (Co), and nickel (Ni) from the recovered leaching solution 120. The recovery efficiency of each of nickel, cobalt, and manganese may be greater than or equal to about 94.5%, such as greater than or equal to 95%. Specifically, the nickel recovery efficiency may be greater than or equal to about 94.5%, or greater than or equal to 95.5%. The cobalt recovery efficiency may be greater than or equal to about 97.7%, and the manganese recovery efficiency may be greater than or equal to about 99.3%. The recovered leaching solution 120 may be directly used to synthesize a battery grade cathode precursor, such as LiMn_{0.33}Ni_{0.33}Co_{0.33}O₂, LiNi_{0.6}Co_{0.2}Mn_{0.2}O₂ and LiNi_{0.8}Co_{0.1}Mn_{0.1}O₂, of Li-ion batteries.

The electrochemical membrane reactor 102 of the electrochemical apparatus 100 as described above and the methods of using the apparatus may have a number of advantages over conventional apparatuses and methods. For example, the advantages may include improved impurity removal, zero (e.g., lack of) introduction of any other chemicals to the leaching solution, and reduction of wastewater emission. Specifically, the electrochemical membrane reactor 102 according to embodiments of the disclosure may significantly improve the nickel, cobalt, and manganese recovery efficiencies while consuming only electricity, water, and compressed air. No additional chemicals are consumed during the methods of using the apparatus. Acid generated by the noble metal anode during the removing aluminum and iron from leaching solution act or during the reactor restoration act of the method of removing impurities may be used in subsequent processing. The electrochemical apparatus 100 may, therefore, be a cost-effective and environmentally sustainable way of recycling spent Li-ion batteries and/or recycling the solutions generated from mine tailings.

The impurity removal method utilizing the electrochemical apparatus 100 of FIG. 1 includes providing a leaching solution source 104. The leaching solution source 104 may be introduced into the electrochemical membrane reactor 102 and may flow into the negative electrode 110 side of the electrochemical membrane reactor 102. The leaching solution source 104 undergoes a series of chemical reactions via electrolysis to remove the impurities and recover desired elements, forming the leaching solution 116. Without being bound by any theory, it is believed that by increasing the local pH value of the leaching solution source 104 to form the leaching solution 116 and by maintaining a low current density, impurities (e.g., Cu²⁺ ions, Al³⁺ ions and Fe³⁺ ions) may be removed and nickel, manganese and cobalt may remain in the leaching solution 116. Alternatively, the nickel and cobalt may be electroplated separately. Specifically, the potential difference (e.g., voltage) is applied between the positive electrode 108 and the negative electrode 110 of the electrochemical membrane reactor 102 by the power source 106. On the positive electrode 108 (e.g., anode) side, the active metal, such as Zn, Fe, Ni, Pb, Al or Cu, may be oxidized to metal ions to balance the reduction reaction on the negative electrode 110 (e.g., cathode) side. If the positive electrode 108 is a noble metal, the oxidation of H₂O to produce O₂ balances the reduction reaction on the negative electrode 110 side.

After conducting the chemical reactions to form the leaching solution 116, the treated leaching solution 118 exits the electrochemical membrane reactor 102 and flows into the vessel 122. The impurities in the treated leaching solution 118 are collected (e.g., filtered out) to produce the recovered leaching solution 120. The impurities, such as Al(OH₃) and Fe(OH₃), remain in the vessel 122 of the electrochemical apparatus 100. After collection (e.g., filtration) of the impurities in the vessel 122, the recovered leaching solution 120 flows from the vessel 122 to the container 124. After the impurity removal method using the electrochemical membrane reactor 102, sulfates such as NiSO₄, COSO₄ and MnSO₄ may be present in the recovered leaching solution 120. The sulfates remaining in the recovered leaching solution in container 124 include substantially similar (e.g., the same) components as the virgin materials for cathode precursor fabrication of Li-ion batteries dissolved into deionized (DI) water.

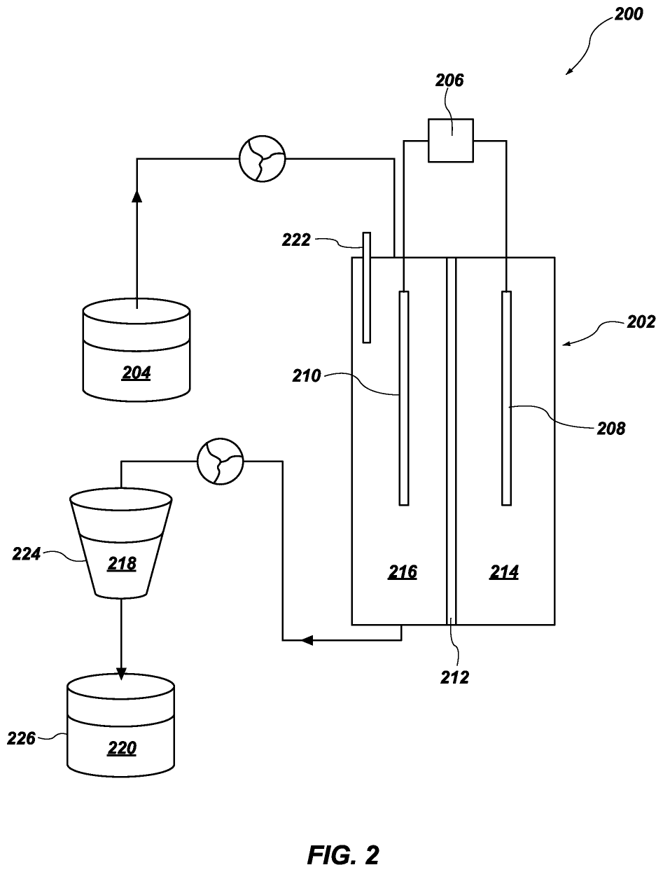

FIG. 2 shows another embodiment of the electrochemical apparatus 200, including an electrochemical membrane reactor 202 that is similar to the electrochemical membrane reactor 102 of FIG. 1, with the difference being a gas tube 222 located on the side of the electrochemical membrane reactor 202 containing a negative electrode 210. The method of using the electrochemical apparatus 200 to increase the pH of a leaching solution 216 to remove impurities may otherwise be similar to the method of using electrochemical apparatus 100 as described above and shown in equations (1)-(8). Only method acts that differ substantially from the method of using the electrochemical apparatus 100 are described.

The electrochemical apparatus 200 includes a leaching solution source 204, an impurity solution 218 in a vessel 224, and a recovered solution 220 in a container 226. The electrochemical membrane reactor 202 of the electrochemical apparatus 200 includes a positive electrode 208, the negative electrode 210, a membrane 212, an anolyte 214, and the leaching solution 216. Similar to the negative electrode 110 of FIG. 1, the negative electrode 210 may be a 2-dimensional (2-D) immerged plate electrode (e.g., immerged plate). The electrochemical membrane reactor 202 is electrically connected (e.g., coupled) to a power source 206. Gas may be introduced through the gas tube 222 and into the leaching solution 216 within the electrochemical membrane reactor 202 to facilitate the reduction of O₂ in the leaching solution 216. The gas purged through the gas tube 222 may be pure oxygen (O₂) gas, air, or a combination thereof. The O₂ is reduced by the negative electrode 210 as described in equation (2). As the O₂ and H₂O within the leaching solution 216 is reduced, the pH of the leaching solution 216 may increase within a range of from about 5.2 to about 12. Specifically, when the pH is increased to about 4, O₂ gas may be introduced through the gas tube 222 into the leaching solution 216 to facilitate the reduction of O₂ in the leaching solution. A higher pH further facilitates the precipitation of impurities, such as aluminum and iron, within the leaching solution 216 and accelerates the removal of such impurities as described in equations (4) and (5).

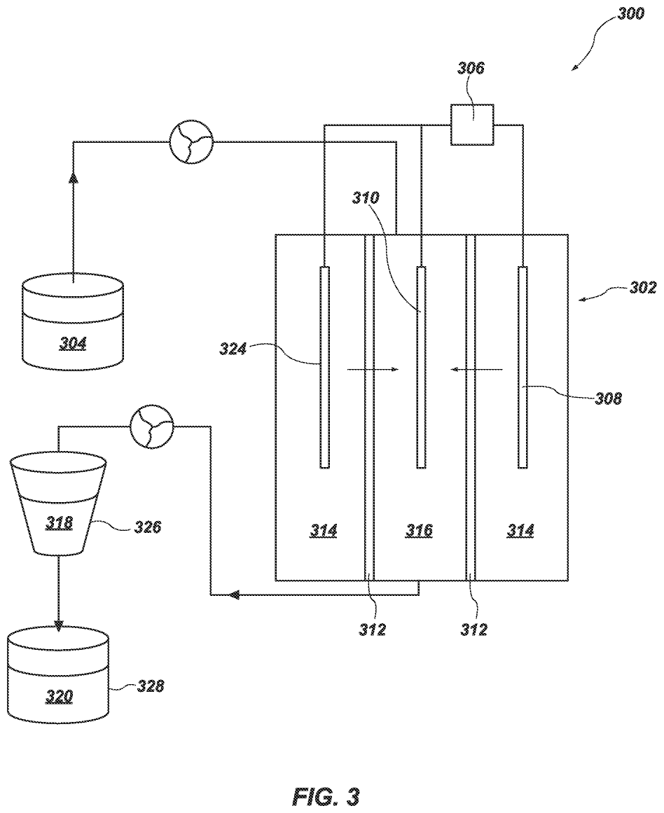

FIG. 3 shows still another embodiment of the electrochemical apparatus 300, including an electrochemical membrane reactor 302 that is similar to the electrochemical membrane reactor 102 of FIG. 1, with the difference being the electrochemical membrane reactor 302 includes an additional negative electrode 324 in an anolyte 314. The method of using the electrochemical apparatus 300 to increase the pH of the leaching solution to remove impurities may otherwise be similar to the method of using electrochemical apparatus 100 as described above. Only method acts that differ substantially from the method of using the electrochemical apparatus 100 are described.

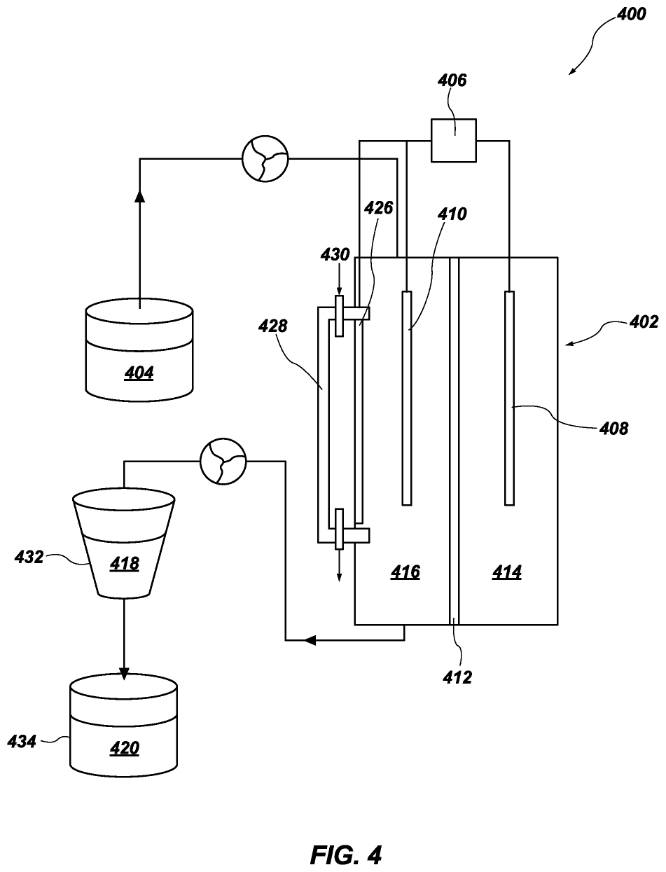

The electrochemical apparatus 300 includes a leaching solution source 304, an impurity solution 318 in a vessel 326, and a recovered solution 320 in a container 328. The electrochemical membrane reactor 302 of the electrochemical apparatus 300 includes a positive electrode 308, a negative electrode 310, a membrane 312, an anolyte 314, and a leaching solution 316. The electrochemical membrane reactor 302 is electrically connected (e.g., coupled) to a power source 306. The electrochemical membrane reactor 302 further includes another membrane 312 disposed between the negative electrode 310 and an additional negative electrode 324, as shown in FIG. 3. The membrane 312 and the other membrane 312 may be the same or different in material composition. The negative electrode 310 and the additional negative electrode 324 may be 2-dimensional (2-D) immerged plate electrodes (e.g., immerged plates) and submerged in the leaching solution 316 and the anolyte 314. The additional negative electrode 324 facilitates the production of OH⁻ by reducing H₂O as described above in equation (2). While the additional negative electrode 324 is separated (e.g., isolated) from the leaching solution 316, the OH⁻ produced at the surface of the additional negative electrode 324 is transported to the leaching solution 316 to facilitate increasing the pH of the leaching solution 316. The electrochemical membrane reactor 302 of electrochemical apparatus 300 differs from the electrochemical apparatus 200 of FIG. 3 in that no 02 gas is purged into the system, as is described with reference to electrochemical apparatus 200 of FIG. 2. FIG. 4 shows yet another embodiment of the electrochemical apparatus 400, including an electrochemical membrane reactor 402 that is similar to the electrochemical membrane reactor 102 of FIG. 1, with the difference being a gas diffusion electrode 426 is included in the electrochemical membrane reactor 402. The method of using the electrochemical apparatus 400 to increase the pH of the leaching solution source 404 to remove impurities may otherwise be similar to the method of using electrochemical apparatuses 100, 200, 300 as described above. Only method acts that differ substantially from the method of using the electrochemical apparatuses 100, 200, 300 are described.

The electrochemical apparatus 400 includes a leaching solution source 404, an impurity solution 418 in a vessel 432, and a recovered solution 420 in a container 434. The electrochemical membrane reactor 402 of the electrochemical apparatus 400 includes a positive electrode 408, a negative electrode 410, the gas diffusion electrode 426, a membrane 412, an anolyte 414, and a leaching solution 416. The electrochemical membrane reactor 402 is electrically connected (e.g., coupled) to a power source 406. The gas diffusion electrode 426 functions as a second cathode in the electrochemical membrane reactor 402 and is exposed to the leaching solution 416, a gas 430, and a gas chamber 428. The reaction at the gas diffusion electrode 426 is initiated by introducing air or pure 02 gas (pure oxygen) into the gas chamber 428. The gas 430 is purged inside of the chamber containing the gas diffusion electrode 426 as shown in FIG. 4 to facilitate the reduction of O₂ in the leaching solution 416.

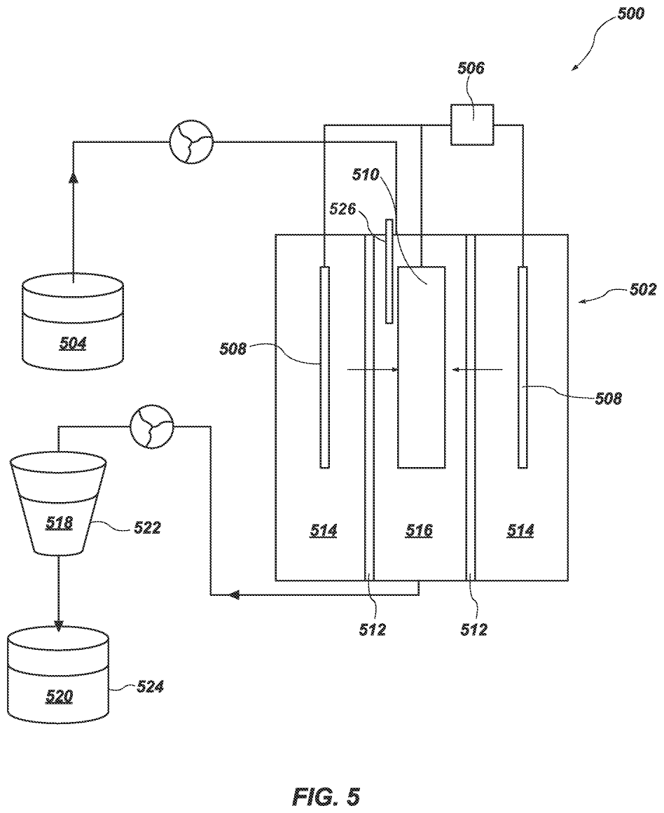

FIG. 5 shows still another embodiment of the electrochemical apparatus 500, including an electrochemical membrane reactor 502 that is similar to the electrochemical membrane reactor 102 of FIG. 1, with the difference being a negative electrode 510 is a 3-dimensional (3-D) porous electrode. The method of using the electrochemical apparatus 500 to increase the pH of the leaching solution to remove impurities may otherwise be similar to the method of using electrochemical apparatuses 100, 200, 300, 400 as described above. Only method acts that differ substantially from the method of using the electrochemical apparatuses 100, 200, 300, 400 are described.

The electrochemical apparatus 500 includes a leaching solution source 504, an impurity solution 518 in a vessel 522, and a recovered solution 520 in a container 524. The electrochemical membrane reactor 502 of the electrochemical apparatus 500 includes a positive electrode 508, a negative electrode 510, a membrane 512, an anolyte 514, and a leaching solution 516. The negative electrode 510 may be a 3-D porous negative electrode 510. The electrochemical membrane reactor 502 is electrically connected (e.g., coupled) to a power source 506. The electrochemical membrane reactor 502 may further include, but is not limited to, another membrane 512 disposed between the negative electrode 510 and an additional positive electrode 508, as shown in the embodiment of FIG. 5. The membrane 512 and the another membrane 512 may be the same or different in material composition. The electrochemical apparatus 500 also includes a gas tube 526 located within the leaching solution 516 of the electrochemical membrane reactor 502. The gas tube 526 is configured to facilitate the reduction of O₂ in the leaching solution 516.

The material of the 3-D porous negative electrode 510 may be a porous material, such as a foam material. The foam material may include at least one of a metal including nickel and copper. The pH of the leaching solution 516 may not be increased too fast and the current density may not be very large. However, the current may need to be increased to shorten the impurity removal time. This may be achieved by increasing the surface area of the negative electrode 510. In some embodiments, the 3-D porous negative electrode 510 is a nickel foam. The 3-D porous negative electrode 510 of electrochemical apparatus 500 may have a substantially larger surface area than the 2-D immerged negative electrode 210 of electrochemical apparatus 200. The large surface area of the 3-D porous negative electrode 510 enables a larger current coupled with a lower current density to be applied to the electrochemical membrane reactor 502. This may result in an impurity removal time that is less than about one-tenth of the amount of time that the electrochemical apparatus 200 with the 2-dimensional (2-D) immerged plate negative electrode 210 utilizes to process the same impurity removal. The electrochemical membrane reactor 502 may increase the pH of the leaching solution 516 to within a range of from about 5.2 to about 12.

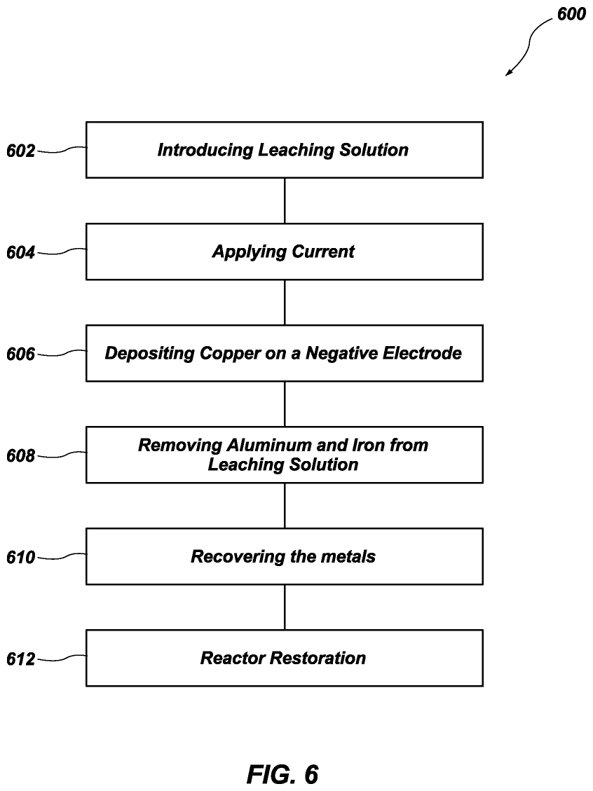

FIG. 6 shows a flow diagram of the method of removing impurities using the electrochemical apparatuses (e.g., the electrochemical apparatuses 100, 200, 300, 400, 500, including the electrochemical membrane reactors 102, 202, 302, 402, 502 thereof) according to embodiments of the disclosure. The method 600 includes the acts of introducing the leaching solution into an electrochemical membrane reactor 602, applying a current through the electrochemical membrane reactor to adjust a pH of the leaching solution 604, depositing the copper on the at least one negative electrode 606, removing the aluminum and the iron from the leaching solution 608, recovering the cobalt, the manganese, and the nickel from the leaching solution 610, and restoring the electrochemical membrane reactor 612.

The methods (e.g., impurity removal method 600) and apparatuses (e.g., the electrochemical apparatuses 100, 200, 300, 400, 500, including the electrochemical membrane reactors 102, 202, 302, 402, 502 thereof) of the disclosure facilitate the simple and efficient removal of impurities (e.g., copper, aluminum, iron) and the recovery of cobalt, manganese, and nickel from a leaching solution. The source of the leaching solution may be obtained from spent Li-ion batteries, ferromanganese slag, or mine tailings. The methods and apparatuses of the disclosure may reduce one or more of the time (e.g., processing time), costs (e.g., material costs), and energy (e.g., thermal energy, electrical energy, etc.) used to recycle the leaching solution relative to conventional methods and apparatuses of recycling leaching solutions. The methods and apparatuses of the disclosure may be more efficient, durable, and reliable that conventional methods, conventional systems, and conventional apparatuses of removing impurities and recovering cobalt, manganese, and nickel.

The following examples serve to explain embodiments of the disclosure in more detail. These examples are not to be construed as being exhaustive or exclusive as to the scope of this disclosure.

### EXAMPLES

### Example 1

### Impurity Removal Process: Using Electrolysis Process

A simulated leaching solution (e.g., simulated leachate) was prepared by using commercial chemical compounds, and the concentration of each was as follows: 3.745 g CuSO₄·5H₂O (Sigma-Aldrich, ACS reagent, purity≥98.0%), 5.941 g Al₂(SO₄)₃·xH₂O (x=14˜18) (Sigma-Aldrich), 0.400 g Fe₂(SO₄)₃·xH₂O (Sigma-Aldrich, purity≥97.0%), 67.604 g MnSO₄·H₂O (Sigma-Aldrich, purity≥99.99%), 23.331 g CoSO₄·7H₂O (Sigma-Aldrich, purity≥99.0%) and 26.285 g NiSO₄·-6H₂O (Sigma-Aldrich, purity≥98%). The chemical compounds listed above were dissolved into 500 ml DI water. The pH value of the solution was adjusted to 1.94 by using H₂SO₄.

The simulated leachate was used as the catholyte and 130 ml was poured into the right cylinder of an “H” shaped electrolytic cell, and 130 ml of 0.05 M H₂SO₄ plus 0.2 M K₂SO₄ (initial pH value=1.74) solution was poured into the left cylinder and used as the anolyte. An anion exchange membrane (FUMASEP® FAA-3-PK-75) was used to separate the anode and the cathode compartments of the electrochemical membrane reactor.

A Cu sheet electrode (dimension of 4.5 cm×3.5 cm×0.1 cm) was used as the cathode, and a Ni plate metal (dimension 2.5 cm×2.0 cm×0.15 cm) was used as the anode. During the impurity removal process, the simulated leachate underwent three stages, as shown in Table 1.

TABLE 1
The reactions for impurities removal from spent Li-ion
batteries in the electrochemical membrane reactor.

| | Cathode reactions | Anode reactions |
|---|---|---|
| Stage 1: Cu | Cu electroplating: Cu²⁺ + 2^{e-} → Cu; | Metal oxidation: |
| removal | Fe3+ ions reduction: Fe³⁺ + e⁻ → Fe²⁺, | Ni − 2e⁻ → Ni²⁺ |
| Stage 2: | pH adjustment to ~5: 2H₂O + O₂ + 4e⁻→ | Metal oxidation: |
| Al and Fe | 4OH⁻, and 2H₂O + 4e⁻→ H₂ + 2OH⁻. | Ni − 2e⁻ → Ni²⁺ |
| removal | Co-precipitation: Al³⁺ + 3OH⁻ → Al(OH)₃↓ | |
| | 4Fe²⁺ + O₂ + 2H₂O → 4Fe³⁺ + 4OH⁻, | |
| | and Fe³⁺ + 3OH⁻ → Fe(OH)₃↓. | |
| Stage 3: | H₂O decomposition: 2H₂O − 4e⁻ → 4H⁺ + O₂, | Metal ion reduction: |
| Reactor | | Ni²⁺ + 2e⁻→ Ni |
| restoration | | |

Samples of the simulated leaching solutions before and after electrolysis were taken for elemental analysis through iCAP Q ICP-MS and Agilent 240FS AA. Impurity precipitation occurred during the electrolysis but was filtered after leaving the solution still overnight. After drying, the filtrate powder was digested with concentrated HCl and HNO₃, and then analyzed with iCAP Q ICP-MS and AAS.

Chronopotentiometry test was applied to the membrane reactor, and the pH values of the catholyte and the anolyte were recorded during the electrolysis. At the beginning, 6.8 mA current (cathode current density: 0.216 mA·cm⁻²) passed through the reactor. The dominant electrochemical reaction on the anode was nickel metal oxidation reaction described by stage 1 cathode reactions equations, as shown in Table 1, as the color of the anolyte solution gradually changed from colorless to green. The reactions that happened on the cathode side were complicated, as two electrochemical reactions were observed to happen at the early stage: (1) O₂ reduction reaction and (2) Cu plating reaction. The pH of the catholyte and the anolyte were measured throughout the experiment. The pH of the catholyte was increased gradually during the electrolysis, by H₂O, O₂ reduction and the generation of OH⁻ ions. During the electrolysis, Cu metal was electroplated on the Cu cathode. When the pH was higher, H₂O₂ could be the intermediate of O₂ reduction. H⁺ ions transportation became rate-determining step and the kinetics of O₂ reduction reaction became sluggish inducing a larger potential polarization for O₂ reduction. Some H₂O may be reduced to produce H₂ while Ni, Co electroplating may also occur on an additional cathode. SO₄²⁻ and OH⁻ anions migrated from the catholyte to the anolyte through the anionic exchange membrane during the electrolysis, and the cationic ions were blocked by the anionic exchange membrane. Even though the mobility of OH⁻ ions is one order of magnitude higher than SO₄²⁻ ions, the concentration of SO₄²⁻ ions is several orders of magnitude higher than OH⁻ ions and, therefore, the dominant migrating ions were SO₄²⁻ ions. While the pH value of both the catholyte and the anolyte increased, the catholyte always had a higher pH value than the anolyte during the electrolysis.

The pH increasing rates of the catholyte and the anolyte were affected by the configuration of the reactor, such as the dimension of the cathode, its distance from the gas dispersion tube and the location of the tube itself. It is also noticed that the O₂ reduction mechanism changed when the pH of the catholyte increased to about 4, as the cell voltage dropped from about −1.75 V to about −2.5 V in 300 minutes.

O₂ reduction has two parallel pathways: (1) A direct four-electron route, without any detectable intermediate, shown in equation (4); and (2) two-stage, serial route, in which H₂O₂ is the intermediate with two-electrons transfer, as shown below in equation (9) and (10). In the pH range of less than 3, the dominant reaction mechanism is the four-electron route; while in the pH interval from 3 to 6, the two-stage, serial route is the dominant reaction mechanism at low potential polarization. In the second reaction mechanism, H⁺ ions were directly involved in the reaction, and their transportation becomes the rate-limited step, slowing down the reaction kinetics of O₂ reduction. When the pH of catholyte is above 4, H⁺ ions concentration is less than 1×10⁻⁴ M. Such a low H⁺ ion concentration did not sustain the reactions (9) and (10) below, with the current of 6.8 mA, and the potential polarization was automatically enlarged, where O₂ underwent direct four electrons route to supply large electrolysis current.

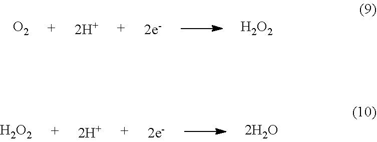

The large overpotential for O₂ reduction induced Ni and Co electroplating. When the pH of the catholyte was 4.13, black deposition appeared together with white precipitation on the surface of copper electrode. To precipitate Al³⁺ and Fe³⁺ ions and keep Co²⁺, Ni²⁺ and Mn²⁺ ions in the leachate, the electrolysis current was adjusted to keep the voltage above −2.0 V, avoiding nickel and cobalt deposition. At the pH of 4.13, the current was decreased to 3.5 mA (cathode current density: 0.111 mA·cm-2); at the pH of 4.25, the current was decreased to 2.5 mA (cathode current density: 0.0794 mA·cm-2), and at the pH of 4.95, the current was decreased to 1.7 (cathode current density: 0.0540 mA·cm-2) mA. When the pH value reached 5.12, the electrolysis was stopped, and Al³⁺ and Fe³⁺ ions were expected to be reduced to less than 10⁻⁵ mol/l-1.

During the proceeding of the Cu electroplating and O₂ reduction, the Ni anode was dissolved into the anolyte, and Ni²⁺ ions recovered by electroplating. The simulated leaching solution (catholyte) and the copper cathode were taken out from the reactor, and substituted by 130 ml 0.2 M K₂SO₄ solution (pH=5.66). The removed catholyte showed clear precipitation. A platinum electrode was inserted into the K₂SO₄ solution as anode and nickel plate was then treated as cathode to electroplate the Ni²⁺ from the solution. A current of 8 mA (cathode current density: 0.8 mA·cm-2) was passed through the reactor, then the current was increased to 16 mA current (cathode current density: 1.6 mA·cm-2). Nickel gradually deposited on the surface of the nickel plate with the green solution color fading and the pH value of K₂SO₄ solution in the right cylinder decreased to 0.96, which can be used as an acid solution for leaching. Ni²⁺ ions concentration solution before recovery was 6525.77 ppm, and it decreased to 26.59 ppm after recovery. The Coulomb efficiency of the Ni recovery is about 83.87%.

Inductively coupled plasma mass spectrometry (ICP) and atomic adsorption spectroscopy (AAS) analysis were used to analyze the solutions before and after electrolysis and the digested precipitation, which was filtered out from the simulated leaching solution by using fine porosity filter paper and then was dried in 75° C. oven overnight. The precipitation weight was obtained by using the weight difference of the filter paper before and after filtering and drying, which was 0.388 g. 40 mg of the precipitate were digested in 20 ml diluted HCl solution (1.5 ml concentrated HCl solution was diluted to 20 ml solution), and the cathode was emerged into 67.9 ml 2 M H₂SO₄ solution to dissolve the deposition. These digested solutions, the simulated solution before and after electrolysis were diluted to 20 times and 400 times for both ICP and AAS analysis. The simulated leaching solution was 130 ml before the electrolysis, and the solution volume reduced to 125 ml after electrolysis and filtering. The concentration of each element in the solutions are shown in Table 2, and their corresponding masses are shown in Table 3. The results demonstrate that Cu²⁺ ions were removed by electroplating from the simulated solution and all Al³⁺ and Fe³⁺ ions were removed by precipitation. Their concentrations after electrolysis and filtering are below the instruments' detection limit.

TABLE 2
The element's concentration of the digested deposition and precipitation,
and the simulated leaching solution before and after electrolysis.

| | Cu/ppm | Al/ppm | Mn/ppm | Fe/ppm | Co/ppm | Ni/ppm |
|---|---|---|---|---|---|---|
| Simulated leaching solution | 1850.2 | 787.14 | 43950.4 | 151.473 | 8859.6 | 11374.3 |
| Digested deposition | 2167.64 | 385.78 | 64.699 | 45.667 | 1012.61 | 324.223 |
| Digested precipitation | 0 | 477.73 | 17.194 | 84.004 | 21.311 | 120.182 |
| Simulated leaching after | 0 | 0 | 45318.3 | 0 | 8788.2 | 10882.3 |
| electrolysis | | | | | | |

TABLE 3
The mass of the elements in the deposition, the precipitation and
in the simulated leaching solution before and after electrolysis.

| | Cu/mg | Al/mg | Mn/mg | Fe/mg | Co/mg | Ni/mg |
|---|---|---|---|---|---|---|
| Simulated leaching solution | 240.526 | 102.328 | 5713.55 | 19.692 | 1151.75 | 1421.79 |
| before electrolysis | | | | | | |
| Cathode Deposit | 147.183 | 26.194 | 4.393 | 3.1 | 68.756 | 22.015 |
| Precipitate | 0 | 70.346 | 4.085 | 11.927 | 3.45 | 18.390 |
| Simulated leaching solution | 0 | 0 | 5664.79 | 0 | 1098.53 | 1414.7 |
| after electrolysis | | | | | | |
| Recovery efficiency | | | 99.14% | | 95.4% | 99.5% |

The aluminum, iron, cobalt and nickel on the surface of the cathode were in a metal state or a precipitation state. The recovery efficiency was 95.4% for cobalt, 99.5% for nickel and 99.14% for manganese. These high recovery efficiencies were achieved without adding a base to the simulated leachate.

### Example 2

Comparative Example: Impurity Removal Process with Adding Base

The comparison of copper, aluminum and iron removal by adding a NaOH solution to the simulated leachate was investigated. Cu²⁺, Al³⁺ and Fe³⁺ ions were removed from the leaching solution of spent Li-ion batteries by adding base for pH adjustment. When the pH value of the simulated leachate was adjusted to 6˜7, Cu²⁺, Al³⁺ and Fe³⁺ ions were removed to the lower concentration of 1×10⁻⁵ M by forming Cu(OH)₂, Al(OH)₃, and Fe(OH)₃ precipitation. Two precipitation tests were performed with 10 M NaOH adding into two volumes of 20 ml of simulated solutions drop by drop. The pH of the tested solutions was increased to 5.12 and 6.40, respectively, and the two solutions were magnetically stirred overnight before the precipitations were filtered out by using fine porosity filter paper. The weights of the precipitations were obtained by using the weight difference of the filter paper before and after filtering and drying. After the vacuum filtration, the solution adjusted to the pH value of 5.12 remained 14.5 ml and its dried precipitation was 0.325 g. The solution adjusted to the pH value of 6.4 remained 16.5 ml, and its dried precipitation was 0.665 g. Comparatively, the electrolysis method in Example 1 had only 0.388 g precipitation, generated from 130 ml simulated leaching solution. The solutions after adding base and filtration were measured with AAS as well and the results are shown in Table 4. The Mn²⁺ ions concentration in the solution with pH 5.12 increased remarkably, and the phenomenon evidenced that water evaporated significantly during vacuum filtration, condensing Mn²⁺ ions concentration. At the pH of 5.12, the precipitation method using the NaOH solution did not remove copper thoroughly, and the cobalt and nickel recovery are only 81.33% and 85.4%, respectively, which is lower than that achieved by the electrolysis method. Cu, Fe and Al were removed completely by adding base to the pH value of 6.4, as shown in Table 4, but Ni recovery was only 55.2% and Co recovery efficiency was only 76.1%. By adding a drop of base solution into the simulated leachate, the local pH value around the drop was significantly higher than other areas, causing nickel and cobalt sedimentation in the area, and these precipitated nickel and cobalt were not completely re-dissolved back into the solution, even though the solution was stirred for overnight. However, the electrolysis method described in Example 1 generated OH⁻ ions in a steady and continuous way in large area, and no abruptly high pH value occurred in a local area.

TABLE 4
The element's concentration of the simulated solutions
after pH adjustment and the precipitation removal.

| | Cu/ppm | Al/ppm | Mn/ppm | Fe/ppm | Co/ppm | Ni/ppm |
|---|---|---|---|---|---|---|
| Simulated leaching | 367.407 | 15.85 | 48651 | 0 | 10441.100 | 12207.600 |
| solution after pH | | | | | | |
| adjustment to 5.12 | | | | | | |
| Digested precipitation at | 217.371 | 130.47 | 164.251 | 23.384 | 60.524 | 117.678 |
| pH = 5.12 | | | | | | |
| Simulated leaching | 0 | 0 | 42342.500 | 0 | 8172.790 | 7287.410 |
| solution after pH | | | | | | |
| adjustment to 6.4 | | | | | | |
| Digested precipitation at | 116.077 | 58.76 | 173.337 | 11.264 | 116.376 | 346.037 |
| pH = 6.4 | | | | | | |

TABLE 5
The mass of the elements in the simulated leaching solution
before and after pH adjustment and precipitation removal.

| | Cu/mg | Al/mg | Mn/mg | Fe/mg | Co/mg | Ni/mg |
|---|---|---|---|---|---|---|
| The simulated leaching solution | 37.004 | 15.743 | 824.146 | 3.03 | 177.192 | 217.646 |
| before pH adjustment and | | | | | | |
| precipitation removal | | | | | | |
| Simulated leaching solution after | 5.327 | 0.230 | 705.440 | 0 | 151.396 | 177.010 |
| adjusting pH to 5.12 and removing | | | | | | |
| precipitation | | | | | | |
| Mass of digested precipitation | 35.323 | 21.201 | 26.691 | 3.800 | 9.835 | 19.123 |
| at pH = 5.12 | | | | | | |
| The recovery efficiency at | | | 85.60% | | 85.4% | 81.33% |
| pH = 5.12 | | | | | | |
| Simulated leaching solution after | 0 | 0 | 698.651 | | 134.851 | 120.242 |
| adjusting pH to 6.4 and removing | | | | | | |
| precipitation | | | | | | |
| Mass of digested precipitation at | 38.596 | 19.538 | 57.635 | 3.745 | 38.695 | 115.057 |
| pH = 6.4 | | | | | | |
| The recovery efficiency at | | | 84.77% | | 76.1% | 55.2% |
| pH = 6.4 | | | | | | |

The measurement and efficiency calculations in Table 3 and Table 5 demonstrate that the electrolysis method according to embodiments of the disclosure is more efficient and selective to remove Cu²⁺, Al³⁺ and Fe³⁺ than the method of adding base for pH adjustment. By adding base for the impurity removal, the Ni and Co recovery efficiencies are strongly dependent on their concentration inside the leaching solution. If the Ni and Co concentrations are higher, their recovery efficiency can be even lower by adding base.

Therefore, it was determined that the electrochemical membrane reactor described in Example 1 electroplated Cu²⁺ ions and reduced compressed air and water to increase the pH value of the simulated leaching solution. When the pH value was increased to 5.12, the impurities, including Cu²⁺, Al³⁺, and Fe³⁺ ions in the solution, were below the detection limit of ICP and AAS, and the reactor had a very high transition metal recovery efficiency: Ni is 95.4%, Co is 99.5% and Mn is 99.14%. Comparatively, the pH value of the simulated leaching solution must be increased to 6.4 by adding base to lower the concentration of Cu²⁺, Al³⁺, and Fe³⁺ ions to 10⁻⁵ mol/l. The nickel recovery efficiency is 55.2% and cobalt recovery efficiency is 76.1% by adding the base.

### Example 3

### Different Sources of Leaching Solution

The leaching solution obtained from Co mines in the US includes laterite, pentlandite, chalcopyrite and cobaltite. The preliminary process to convert the metal sulfides, such as pentlandite, chalcopyrite and cobaltite, is roasting the metal sulfides into metal oxides and metal sulfates, and then the metal sulfides are dissolved by the H₂SO₄. Residual solids are filtered out of the leachate before being pumped into electrochemical membrane reactor. The residual solids are measured by ICP instrument to detect the concentration of Cu, Al, Zn, Mn, Ni, Co, Cr, Si, platinum group elements, or As (if it is cobaltite or). Electric capacity, passing through the membrane reactor, is estimated based on the concentration of each element listed above. The reactions that occur inside the reactor are shown in Table 6. In stage 1, the concentration of Cu and platinum group elements are lowered to 10⁻⁶ M by electroplating, because their electroplating potential is larger than H₂O reduction potential. In stage 2, the pH value of the leaching solution is adjusted to 5 by reducing O₂ and H₂O to produce OH⁻ ions, precipitating Al, Fe, and Cr to the concentration of 10⁻⁶ M, based on the Ksp value of their hydroxide. After stage 2, the main elements in the solution are Co, Ni, Zn, Mn, Mg and Si (or As, if it is cobaltite ore). Electroplating Mn, Mg, and Si in an aqueous solution is not possible as the potential is at least 600 mV lower than the potential of decomposing H₂O. Only Co, Ni, Zn (and As, if it is cobaltite) are electroplated from the leaching solution in stage 4. At a pH of about 6, the potentials for electroplating Ni, Co and As are very close, but more than 480 mV higher than the potential for electroplating Zn. This potential gap is large enough to separate Co and Ni from Zn. For example, if the leaching solution has 1 mM Co and Ni, and 2 mM Zn, in order to lower the Co and Ni concentration to 1×10⁻⁵ M, the cathode needs the potential of −0.425 V (vs. Standard Hydrogen Electrode (SHE)) for Co, and −0.398 V (vs. SHE) for Ni. To electroplate 2 mM Zn²⁺, −0.843 V (vs. SHE) is required. Given 200 mV overpotential for electroplating Ni and Co, there is still more than 200 mV voltage gap between electroplating Ni, Co, and Zn. Based on the above analysis, Ni and Co are extracted from primary sources with very high purity. The electroplated Ni and Co are re-dissolved into H₂SO₄ to form a NiSO₄ and CoSO₄ mixture solution, which is directly applied to synthesize nickel-manganese-cobalt (NMC) precursor. If the ore is cobaltite, which has as low of an electric conductivity as As metal, a trace amount of As will be co-electroplated to form Co—Ni—As alloy. To purify Co and Ni, the alloy will be re-dissolved into acid and Co and Ni will be precipitated by pH adjustment. After Co and Ni extraction, in stage 4, the current direction will be switched again and the dissolved metal from anode electroplates on the anode. On the cathode, H₂O is oxidized to O₂ and H⁺ ions, which is used in the next leaching act. The reactor only consumes electricity, air, and H₂O to extract pure Co—Ni alloy. Ferromanganese slag has similar elements as a Co mine leaching solution, such as: Mn, Al, Fe, Cu, Si, Mg, and Ca. The reactor removes Al, Cu, Fe first, and adjusts the pH value to ˜9.5, precipitating Mn as Mn(OH)₂ with very high impurity.

TABLE 6
The reactions for impurities removal and Co, Ni extraction
from the Co mine using membrane reactor.

| | The reactions happened on cathode | The anode reactions |
|---|---|---|
| Stage 1: Cu, | Cu electroplating: Cu²⁺ + 2e⁻ → Cu or | Metal oxidation: |
| platinum group | platinum group element plating; Fe³⁺ | Zn − 2e⁻ → Zn²⁺ |
| removal | reduction: Fe³⁺ + e⁻ → Fe²⁺, | |
| Stage 2: | pH adjustment to 5: 2H₂O + 2e⁻→ H₂ + | Metal oxidation: |
| Al, Cr removal | 2OH₋, | Zn − 2e⁻ → Zn²⁺ |
| | 2H₂O + O₂ + 4e⁻ → 4OH⁻, and co- | |
| | precipitation: Al³⁺ + 3OH⁻ → Al(OH)₃, | |
| | Fe³⁺ + 3OH⁻ → Fe(OH)₃, Cr³⁺ + 3OH⁻ → | |
| | Cr(OH)₃ | |
| Stage 3: Co and Ni | pH adjustment to ~6: 2H₂O + 2e⁻ → H₂ + | Zn − 2e⁻→ Zn²⁺ |
| extraction | 2OH⁻, and electroplating: Ni²⁺ + 2e⁻ → Ni, | |
| | Co²⁺ + 2e⁻ → Co and co-precipitation: | |
| | Zn²⁺ + 2OH⁻ → Zn(OH)₂ | |
| Stage 4: Reactor | H₂O decomposition: 2H₂O − 4e⁻ → 4H⁺ + | Metal ion reduction: |
| restoration | O₂, | Zn²⁺ − 2e⁻→ Zn |

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

Additional non-limiting example embodiments of the disclosure are described below.

Embodiment 1: A method of removing impurities using an electrochemical apparatus, the method comprising introducing a leaching solution into an electrochemical membrane reactor, the leaching solution comprising copper, aluminum, iron, cobalt, manganese, and nickel, the electrochemical membrane reactor comprising at least one positive electrode and at least one negative electrode, and the leaching solution in contact with the at least one negative electrode, applying a current through the electrochemical membrane reactor to adjust a pH of the leaching solution, depositing the copper on the at least one negative electrode, removing the aluminum and the iron from the leaching solution, and recovering the cobalt, the manganese, and the nickel from the leaching solution.

Embodiment 2: The method of Embodiment 1, wherein introducing the leaching solution into the electrochemical membrane reactor comprises introducing an aqueous leaching solution into the electrochemical membrane reactor.

Embodiment 3: The method of Embodiment 1 or Embodiment 2, wherein introducing a leaching solution into an electrochemical membrane reactor comprises introducing the leaching solution obtained from spent lithium ion batteries, ferromanganese slag, or mining tailings into the electrochemical membrane reactor.

Embodiment 4: The method of any one of Embodiments 1 through 3, wherein recovering the cobalt, manganese, and nickel from the leaching solution comprises recovering greater than or equal to about 95% of each of the cobalt, manganese, and nickel from the leaching solution.

Embodiment 5: The method of any one of Embodiments 1 through 4, wherein applying a current through the electrochemical membrane reactor comprises applying a voltage between the at least one positive electrode and the at least one negative electrode of the electrochemical membrane reactor by a power source.

Embodiment 6: The method of any one of Embodiments 1 through 5, wherein applying a current through the electrochemical membrane reactor comprises increasing the pH of the leaching solution to within a range of from about 5.2 to about 12.

Embodiment 7: The method of any one of Embodiments 1 through 6, wherein applying a current through the electrochemical membrane reactor to adjust a pH of the leaching solution comprises increasing the pH of the leaching solution without adding a base to the leaching solution.

Embodiment 8: The method of any one of Embodiments 1 through 7, wherein depositing copper on the at least one negative electrode comprises electroplating the at least one negative electrode with the copper.

Embodiment 9: The method of any one of Embodiments 1 through 8, wherein removing the aluminum and the iron from the leaching solution comprises forming aluminum precipitates and iron precipitates, and filtering the aluminum precipitates and the iron precipitates from the leaching solution.

Embodiment 10: The method of any one of Embodiments 1 through 9, wherein recovering the cobalt from the leaching solution comprises recovering greater than or equal to about 97% of the cobalt from the leaching solution.

Embodiment 11: The method of any one of Embodiments 1 through 10, wherein recovering the manganese from the leaching solution comprises recovering greater than or equal to about 99% of the manganese from the leaching solution.

Embodiment 12: The method of any one of Embodiments 1 through 11, wherein recovering the nickel from the leaching solution comprises recovering greater than or equal to 95.5% of the nickel from the leaching solution.

Embodiment 13: An electrochemical membrane apparatus, the electrochemical membrane apparatus comprising an electrochemical membrane reactor comprising, at least one positive electrode configured to act as a sacrificial anode or a noble metal anode, at least one negative electrode configured to provide a base material for electroplating a metal from a leaching solution source coupled to the electrochemical membrane reactor, and at least one membrane between the at least one positive electrode and the at least one negative electrode and formulated to conduct ions from the positive electrode to the negative electrode, and a power source electrically coupled to the positive electrode and the negative electrode and configured to apply current between the negative electrode and the positive electrode.

Embodiment 14: The electrochemical membrane apparatus of Embodiment 13, further comprising the at least one negative electrode configured to provide a base to precipitate metal ions.

Embodiment 15: The electrochemical membrane apparatus of Embodiment 13 or Embodiment 14, wherein the membrane is formulated to conduct SO₄²⁻ ions from the at least one positive electrode to the at least one negative electrode.

Embodiment 16: The electrochemical membrane apparatus of any one of Embodiments 13 through 15, wherein the at least one positive electrode comprises at least one of nickel (Ni), zinc (Zn), copper (Cu), iron (Fe), lead (Pb), platinum (Pt), cobalt (Co), titanium (Ti) coated with iridium oxide (IrO₂), gold (Au), or titanium coated with platinum.

Embodiment 17: The electrochemical membrane apparatus of any one of Embodiments 13 through 16, wherein the at least one negative electrode comprises at least one of graphite, copper, iron, titanium, or nickel.

Embodiment 18: The electrochemical membrane apparatus of any one of Embodiments 13 through 17, wherein the at least one membrane comprises an electrolyte material having an ionic conductivity greater than or equal to about 1.5 millisiemens per centimeter (mS/cm).

Embodiment 19: The electrochemical membrane apparatus of any one of Embodiments 13 through 18, wherein the at least one negative electrode comprises a 3-D porous material.

Embodiment 20: The electrochemical membrane apparatus of any one of Embodiments 13 through 19, further comprising a gas diffusion negative electrode coupled to the electrochemical membrane reactor.

Embodiment 21: The electrochemical membrane apparatus of any one of Embodiments 13 through 20, further comprising a gas tube located within the electrochemical membrane reactor and into the leaching solution, and configured to facilitate the reduction of O₂ in the leaching solution.

Embodiment 22: The electrochemical membrane apparatus of any one of Embodiments 13 through 21, wherein the electrochemical membrane reactor comprises an additional negative electrode to facilitate the production of hydroxide ions by reducing water.

Embodiment 23: The electrochemical membrane apparatus of any one of Embodiments 13 through 22, wherein the electrochemical membrane reactor comprises an additional membrane between the at least one negative electrode and the additional negative electrode.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

1. A method of removing impurities using an electrochemical apparatus, comprising:
introducing a leaching solution into an electrochemical membrane reactor, the leaching solution comprising copper, aluminum, iron, cobalt, manganese, and nickel, the electrochemical membrane reactor comprising at least one positive electrode and at least one negative electrode, and the leaching solution in contact with the at least one negative electrode;
applying a current through the electrochemical membrane reactor to adjust a pH of the leaching solution;
depositing the copper on the at least one negative electrode;
removing the aluminum and the iron from the leaching solution; and
recovering the cobalt, the manganese, and the nickel from the leaching solution.

2. The method of claim 1, wherein introducing the leaching solution into the electrochemical membrane reactor comprises introducing an aqueous leaching solution into the electrochemical membrane reactor.

3. The method of claim 1, wherein introducing a leaching solution into an electrochemical membrane reactor comprises introducing the leaching solution obtained from spent lithium ion batteries, ferromanganese slag, or mining tailings into the electrochemical membrane reactor.

4. The method of claim 1, wherein recovering the cobalt, manganese, and nickel from the leaching solution comprises recovering greater than or equal to about 95% of each of the cobalt, manganese, and nickel from the leaching solution.

5. The method of claim 1, wherein applying a current through the electrochemical membrane reactor comprises applying a voltage between the at least one positive electrode and the at least one negative electrode of the electrochemical membrane reactor by a power source.

6. The method of claim 1, wherein applying a current through the electrochemical membrane reactor comprises increasing the pH of the leaching solution to within a range of from about 5.2 to about 12.

7. The method of claim 1, wherein applying a current through the electrochemical membrane reactor to adjust a pH of the leaching solution comprises increasing the pH of the leaching solution without adding a base to the leaching solution.

8. The method of claim 1, wherein depositing copper on the at least one negative electrode comprises electroplating the at least one negative electrode with the copper.

9. The method of claim 1, wherein removing the aluminum and the iron from the leaching solution comprises forming aluminum precipitates and iron precipitates, and filtering the aluminum precipitates and the iron precipitates from the leaching solution.

10. The method of claim 1, wherein recovering the cobalt from the leaching solution comprises recovering greater than or equal to about 97% of the cobalt from the leaching solution.

11. The method of claim 1, wherein recovering the manganese from the leaching solution comprises recovering greater than or equal to about 99% of the manganese from the leaching solution.

12. The method of claim 1, wherein recovering the nickel from the leaching solution comprises recovering greater than or equal to 94.5% of the nickel from the leaching solution.

13. An electrochemical membrane apparatus, comprising:
an electrochemical membrane reactor comprising:
at least one positive electrode configured to act as a sacrificial anode or a noble metal anode;
at least one negative electrode configured to provide a base material for electroplating a metal from a leaching solution source coupled to the electrochemical membrane reactor; and
at least one membrane between the at least one positive electrode and the at least one negative electrode and formulated to conduct ions from the positive electrode to the negative electrode; and
a power source electrically coupled to the positive electrode and the negative electrode and configured to apply current between the negative electrode and the positive electrode.

14. The electrochemical membrane apparatus of claim 13, further comprising the at least one negative electrode configured to provide a base to precipitate metal ions.

15. The electrochemical membrane apparatus of claim 13, wherein the at least one membrane is formulated to conduct SO₄²⁻ ions from the at least one positive electrode to the at least one negative electrode.

16. The electrochemical membrane apparatus of claim 13, wherein the at least one positive electrode comprises at least one of nickel (Ni), zinc (Zn), copper (Cu), iron (Fe), lead (Pb), platinum (Pt), cobalt (Co), titanium (Ti) coated with iridium oxide (IrO₂), gold (Au), or titanium coated with platinum.

17. The electrochemical membrane apparatus of claim 13, wherein the at least one negative electrode comprises at least one of graphite, copper, iron, titanium, or nickel.

18. The electrochemical membrane apparatus of claim 13, wherein the at least one membrane comprises an electrolyte material having an ionic conductivity greater than or equal to about 1.5 millisiemens per centimeter (mS/cm).

19. The electrochemical membrane apparatus of claim 13, wherein the at least one negative electrode comprises a 3-D porous material.

20. The electrochemical membrane apparatus of claim 13, further comprising a gas diffusion negative electrode coupled to the electrochemical membrane reactor.

21. The electrochemical membrane apparatus of claim 13, further comprising a gas tube located within the electrochemical membrane reactor and into the leaching solution source, and configured to facilitate reduction of O₂ in the leaching solution source.

22. The electrochemical membrane apparatus of claim 13, wherein the electrochemical membrane reactor comprises an additional negative electrode to facilitate production of hydroxide ions by reducing water.

23. The electrochemical membrane apparatus of claim 22, wherein the electrochemical membrane reactor comprises an additional membrane between the at least one negative electrode and the additional negative electrode.
